(19) United States
(12) Patent Application Publication
(10) Pub. No.: US 2006/0119768 A1
(43) Pub. Date: Jun. 8, 2006

(54) Color filter substrate, method for manufacturing color filter substrate, color liquid crystal display device, and method for manufacturing color liquid crystal display device

(75) Inventor: Tatsuya Ito, Matsumoto-shi (JP)

Correspondence Address: OLIFF & BERRIDGE, PLC, P.O. BOX 19928, ALEXANDRIA, VA, 22320, US

(73) Assignee: SEIKO EPSON CORPORATION, TOKYO (JP)

(21) Appl. No.: 11/330,176

(22) Filed: Jan. 12, 2006

Related U.S. Application Data
(62) Division of application No. 09/985,603, filed on Nov. 5, 2001.

(30) Foreign Application Priority Data
Nov. 14, 2000 (JP) 2000-346933

(51) Int. Cl. G02F 1/1335

(52) U.S. Cl. 349/106

(57) ABSTRACT

The number provides a color filter substrate that is provided with various types of product information that is necessary to manufacture a high-resolution color filter and a high-resolution color liquid crystal device with high accuracy and high efficiency. A color filter substrate, which is used for a color filter that performs a color display in a liquid crystal display device, includes a substrate, at least one color filter element formed of a plurality of pixels, placed in a matrix with a predetermined spacing on the substrate, and product information elements placed in the region other than the region in which the color filter element is placed on the substrate, in the same plane as the plane in which the color filter element is placed.

This is a Division of application Ser. No. 09/985,603 filed Nov. 5, 2001. The entire disclosure of the prior application is incorporated by reference herein in its entirety.

### BACKGROUND OF THE INVENTION

1. Field of Invention

The present invention relates to a color filter substrate and a method for manufacturing the color filter substrate, and to a color liquid crystal display device and a method for manufacturing the color liquid crystal display device. More particularly, the invention relates to a color filter substrate used for a color filter that performs a color display in a liquid crystal display device, and in which a product information element is provided in a region other than the region in which the color filter element is placed on the substrate, in the same plane as the plane in which the color filter element is placed. The invention also relates to a method for manufacturing the color filter substrate, to a color liquid crystal display device, and to a method for manufacturing the color liquid crystal display device.

2. Description of Related Art

Recently, with the development of personal computers, and in particular, with the development of mobile personal computers, the demand for color liquid crystal display devices has rapidly increased. The color liquid crystal display devices are widely used for notebook personal computers, desktop personal computers, car navigation systems, electronic still cameras, game machines, projectors, mobile phones, etc.

In such color liquid crystal display devices, the color filters are usually integrated into the liquid crystal display devices so that the display quality is enhanced and the individual pixels in the devices are colored. For example, a screen using thin-film transistors (TFTs) is controlled by a bit map, in which one dot on the screen corresponds to one memory in the computer. In such a case, the entire screen is subdivided like a grid, and color information and luminance information are provided for each pixel of the color filter. For example, in a high-definition television (HDTV), 1,024×1,536×3 pixels are required. Consequently, as the number of pixels that constitute the screen is increased, a higher-resolution image can be displayed. This creates the requirement that the pixels in the color filter be formed with higher accuracy.

In order to meet such a requirement, an ink-jet printing technique has been used for the formation (coloration) of pixels in the manufacture of the color filter.

In this technique, ink is stored in pressure chambers of an ink-jet head using piezoelectric thin-film elements, and the ink is ejected in response to a change in the volume of the pressure chambers due to the vibration of the piezoelectric element causing pixels to be formed on the color filter substrate. The ink-jet printing technique is superior to other techniques because, unlike the formation of pixels by a photolithographic technique which has been conventionally used, it is not necessary to perform complex steps of exposure, development, cleaning, etc., using masks with different patterns for the individual pixels, resulting in an enhancement in productivity and an accurate control in the amounts of inks, and thus it is possible to manufacture high-resolution color filters efficiently.

When a color filter is manufactured using such an ink-jet printing technique, nozzles of the ink-jet head must accurately pass through the region in which the pixels are formed, and also the ink-jet head must be accurately moved so that the ink is ejected at appropriate positions. In order to solve the above-mentioned difficulties, various methods have been disclosed, such as a method for controlling the movement of the ink-jet head by directly detecting a position of the pixel and by correcting a relative position of the pixel and the nozzle so as to be aligned with each other (Japanese Unexamined Patent Application Publication No. 8-82707).

### SUMMARY OF THE INVENTION

However, in order to manufacture a color filter with high accuracy and high efficiency using an ink-jet printing technique, in addition to the difficulties described above, various other problems described below remain unsolved in the manufacturing process, and satisfactory countermeasures have not been established.

For example, when the color filters are manufactured, various defects may occur before the pixel forming step on the substrate, and if the subsequent step is continuously performed, defective and ineffective end products are manufactured, resulting in a decrease in yield as well as a waste of time and materials.

With respect to this problem, under the present situation, whenever a defect occurs, it is recorded on a predetermined work sheet, and work is continued in the subsequent step while referring to the work sheet. However, the worker must move from the production line to the place where the work sheet is stored in order to check the defects, thereby being a significantly inefficient process.

The above-mentioned problem could be solved by attaching a defective notice by photolithography or the like to the periphery of the substrate (motherboard) when the defect is discovered, and in the subsequent step, the defect can be removed with reference to the notice. However, the production line must be stopped for a brief period of time to perform complex steps, such as exposure, development, and cleaning, and also, depending on the type of defect, the mask, etc., used in photolithography must be changed every time. Thereby, an increase in production cost is unavoidable, and it is difficult to practically employ the above method.

Additionally, a lot number, a manufacturing condition, a position of the color filter element, a flow time, a manufacturing apparatus number, a manufacturing apparatus head number, etc., constitute product information which is necessary to achieve work with high accuracy and high efficiency, not only in the manufacturing process of the color filter substrate, but also in the subsequent process of manufacturing the color filter and a color liquid display device. Although it is desired that such product information be attached to the parts themselves flowing in the production line of the color filter substrate in view of continuous and prompt information transmission from one step to another step, such a method has not yet been achieved.

With respect to a liquid crystal-sealing position and an integrated circuit-mounting position when the color filter and color liquid crystal display device are manufactured using the color filter substrate, under the present situation, whenever sealing of the liquid crystal and mounting of the integrated circuit are performed, alignment mechanisms, etc. are used, which are not always an efficient method in view of the continuous and prompt transmission of necessary information.

The present invention addresses the problems described above. It is an object of the present invention to provide a color filter substrate that is provided with various types of product information necessary to manufacture a high-resolution color filter and a high-resolution color liquid crystal device with high accuracy and high efficiency.

It is another object of the present invention to provide a method for manufacturing the color filter substrate, in which the color filter substrate that is provided with various types of product information necessary to manufacture the high-resolution color filter and the high-resolution color liquid crystal device with high accuracy and high efficiency can be efficiently manufactured without an additional manufacturing step, without adding a special unit to an ink-jet head, and without adding a special operation, etc.

It is yet another object of the present invention to provide a color liquid crystal display device using a color filter substrate capable of performing a high-resolution display, and to provide a method for manufacturing the color liquid crystal display device, in which the high-resolution color liquid crystal display device can be manufactured with high accuracy and high efficiency using the method for manufacturing the color filter substrate.

In one aspect of the present invention, in order to achieve the above objects, a color filter substrate, which is used for a color filter that performs a color display in a liquid crystal display device, includes a substrate; at least one color filter element that includes a plurality of pixels, placed in a matrix with a predetermined spacing on the substrate; and a product information element placed in a region other than the region in which the color filter element is placed on the substrate, in the same plane as the plane in which the color filter element is placed.

By employing the structure described above, it is possible to provide a color filter substrate provided with various product information elements that are necessary to manufacture a high-resolution color filter and a high-resolution color liquid crystal display device with high accuracy and high efficiency.

In the present invention, preferably, the product information element contains at least one type of substrate information that is selected from a group that includes a lot number, a manufacturing condition, a position of the color filter element, a defective notice, a flow time, a manufacturing apparatus number, and a manufacturing apparatus head number.

By employing such a structure, since the necessary product information element is attached to the part itself flowing in the production line of the color filter substrate, information is continuously transmitted from one step to another step, and thereby smooth and efficient work can be achieved in the individual manufacturing processes of the color filter substrate, the color filter, and the color liquid crystal display device.

In the present invention, preferably, the product information element contains at least one type of panel information that is selected from a group that includes a liquid crystal-sealing position and an integrated circuit-mounting position when the color filter or the color liquid crystal display device is manufactured using the color filter substrate.

By employing such a structure, in the same way as described above, since information is continuously transmitted, highly accurate and highly efficient work can be achieved in the subsequent manufacturing processes of the color filter, and the color liquid crystal display device.

In the present invention, preferably, the product information element contains at least one type of information selected from a group that includes a character, graphics, a symbol, a bar code, and a verified code.

By employing such a structure, the scope of application of the mode of the product information element can be broadened, and necessary information can be attached in an optimum mode according to the nature thereof.

In the present invention, preferably, the product information element is placed in the inside area of the outer edge of each color filter element placed on either end, or in the vicinity thereof, in a region other than the region in which the color filter element is placed on the substrate.

By employing such a structure, the product information element can be formed smoothly and efficiently within the scanning range of the ink-jet head during the formation of the pixels, without providing a special unit to move the ink-jet head outside the scanning range on the manufacturing apparatus, or without performing a special operation.

In the present invention, preferably, the material constituting the product information element is the same as the material constituting the color filter element.

By employing such a structure, the ink-jet head, ink, etc. that are used during the formation of the pixels can be used in their current form to provide the product information elements, without special working or modification, and thus production costs can be reduced.

In another aspect of the present invention, a method for manufacturing a color filter substrate includes the steps of forming a plurality of pixels with a predetermined spacing on a substrate by scanning an ink-jet head using an ink-jet process, and placing at least one color filter element that includes the plurality of pixels in a matrix with a predetermined spacing, wherein a product information element is placed by scanning the ink-jet head before, after, or simultaneously with the placement of the color filter element, in the same plane as the plane in which the color filter element is placed or has been placed, in the region other than the region in which the color filter element is placed or has been placed on the substrate.

By employing such a structure, since the scanning of the ink-jet head during the formation of the pixels can be used in its current form, it is possible to efficiently manufacture a color filter substrate that is provided with various product information necessary to manufacture a high-resolution color filter and a high-resolution color liquid crystal device with high accuracy and high efficiency, without an increase in the manufacturing step, without adding a special unit to the ink-jet head, or without adding a special operation, etc.

As a variation of the manufacturing method in the present invention, a method for manufacturing color filter substrates can include the step of repeating the method for manufacturing the color filter substrate described above a plurality of times so that the color filter element and the product information element are placed on each of the plurality of substrates, wherein the individual substrates may have different product information elements arranged on a plurality of substrates.

By employing such a structure, a plurality of color filter substrates that are provided with the product information elements can be continuously manufactured without providing a special unit or without performing a special operation, for example, by only once inputting different product information elements to a control software program for the ink-jet head. Thereby, the production rate can be enhanced, resulting in a reduction in production costs.

In yet another aspect of the present invention, a color liquid crystal display device includes a panel chip cut from the color filter substrate described above so as to contain a predetermined number of color filter elements and product information elements; and a protective layer, a common electrode, a pixel electrode substrate, a pixel electrode formed on the pixel electrode substrate so as to be opposed to the common electrode, and a liquid crystal layer interposed and sealed between the two opposed electrodes provided on the panel chip.

By employing such a structure, it is possible to provide a color liquid crystal display device including the color filter substrate capable of performing a high-resolution display.

In yet another aspect of the present invention, a method for manufacturing a color liquid crystal display device includes the steps of forming a color filter substrate by the method for manufacturing a color filter substrate described above; cutting a panel chip containing a predetermined number of color filter elements and product information elements from the color filter substrate; referring to the substrate information and the panel information constituting the product information element; forming a protective layer and a common electrode on the panel chip; forming a pixel electrode on a pixel electrode substrate so as to be opposed to the common electrode; and interposing and sealing a liquid crystal layer between the two opposed electrodes.

By employing such a structure, it is possible to manufacture a high-resolution color liquid crystal display device with high accuracy and high efficiency.

### BRIEF DESCRIPTION OF THE DRAWINGS

FIG. 1 is a plan view which schematically shows a color filter substrate in an embodiment of the present invention;

FIG. 2 is an enlarged plan view showing a part of a color filter element shown in FIG. 1;

FIG. 3 is a sectional view which schematically shows an area in which pixels are formed in an embodiment of the present invention as a color filter substrate;

FIG. 4 is an enlarged plan view showing an area in which product information elements are formed in an embodiment of the present invention as a color filter substrate;

FIG. 5(a) is a plan view which schematically shows a panel chip cut from a color filter substrate in an embodiment of the present invention, and FIG. 5(b) is a sectional view taken along plane A-A of FIG. 5(a);

FIG. 6 is a perspective assembly view which schematically shows an ink-jet head used in the present invention;

FIG. 7 is a schematic diagram showing the electrical connection in an ink-jet head used in the present invention;

FIG. 8 is a sectional view which schematically shows a color liquid crystal display device of the present invention.

### DETAILED DESCRIPTION OF PREFERRED EMBODIMENTS

The present invention will be described in more detail with reference to the drawings.

1. Color Filter Substrate

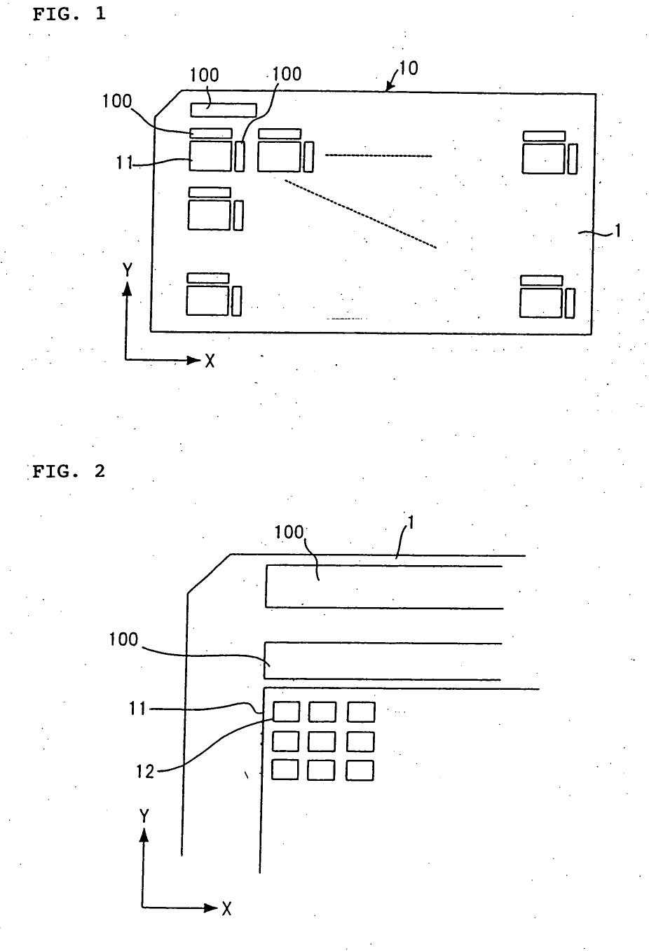

As shown in FIG. 1, a color filter substrate 10 of the present invention is used as a color filter that performs a color display in a liquid crystal display device. The color filter substrate 10 includes a substrate 1. The following elements are arranged on substrate 1: a matrix with defined spacing, at least one color filter element 11 formed of a plurality of pixels, and product information elements 100 placed in a region other than the region in which the color filter element 11 is placed on the substrate 1, and placed in the same plane as the plane in which the color filter element 11 is placed.

Any substrate having a superior mechanical strength may be used as the substrate 1 used for the color filter substrate 10 of the present invention. Examples of such a substrate include a light-transmissive substrate, such as a transparent glass substrate or a plastic substrate (film) formed of an acrylic resin or the like, and a surface-treated article thereof, or a reflective substrate in which a reflecting film is formed on a substrate.

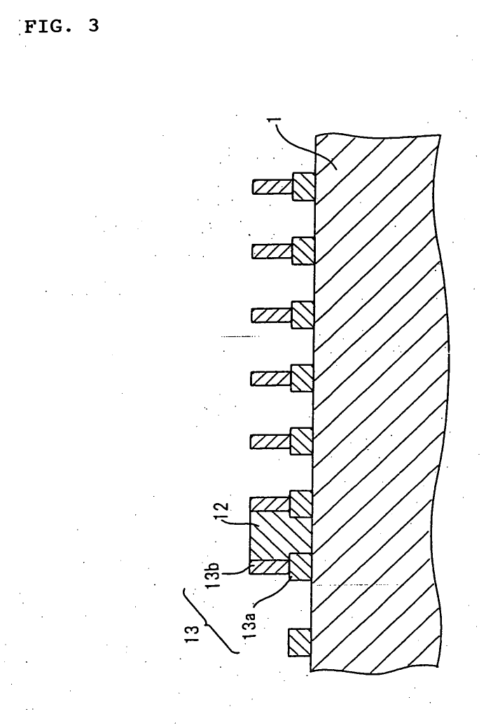

As shown in FIG. 2, a plurality of the color filter elements 11 is placed in a matrix on the substrate 1. For example, the substrate 1 has a size of 470 mm in the X direction and 370 mm in the Y direction. The color filter substrate 10 is of similar dimensions. Each of the color filter elements 11 is formed of a plurality of pixels 12 placed in the matrix.

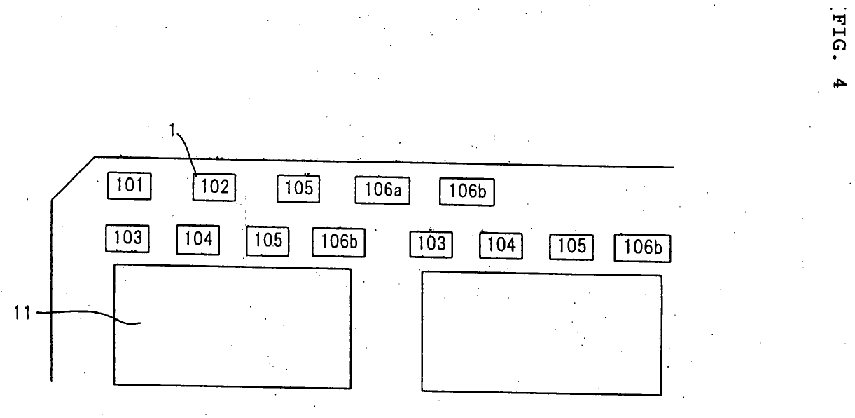

As shown in FIG. 3, partition members 13 are placed in the spaces between the individual pixels 12. The partition members 13 include a black matrix 13a formed of a light-shielding material, such as chromium, and a bank 13b, for example, formed of a resin. The black matrix 13a and the bank 13b may be formed using a conventional photolithographic technique.

In the present invention, ink used to form the pixels may be aqueous or solvent-based. For example, an ink is used in which an inorganic pigment is dispersed in a polyurethane resin oligomer, and cyclohexanone and butyl acetate as low boiling point solvents and butyl carbitol acetate as a high boiling point solvent are added thereto, and then 0.01% of a nonionic surface active agent is added as a dispersant, and in which the viscosity is set at 6 to 8 mPa˜s.

The color filter element 11 may have various sizes depending on the size of the required color filter. In this embodiment, the size of the color filter element 11 is 2.5 inches measured diagonally.

The pixel 12 may be of various sizes and pitches depending on the resolution of required color filter. In this embodiment, the pitch in the X direction is 114 μm, the pitch in the Y direction is 75 μm, and the width of the partition member 13 is 20 μm.

In this embodiment, the height from the substrate 1 to the top of the bank 13b is 2.8 μm to 3.3 μm, and the volume of the pixel 12 surrounded with the partition member 13 is approximately 10 pl (picoliters).

As shown in FIG. 4, in this embodiment, the product information elements (represented by reference number 100 in FIGS. 1 and 2) include substrate information that includes a lot number 101, a manufacturing condition 102, a position of a color filter element 103, a defective notice 104, a flow time 105, a manufacturing apparatus number 106a, and a manufacturing apparatus head number 106b.

In such a structure, since necessary product information elements are attached to the parts themselves on the production line of the color filter substrate, product information is continuously transmitted from one step to another, and thereby smooth and efficient work can be achieved in the individual manufacturing processes of the color filter substrate, the color filter, and the color liquid crystal display device.

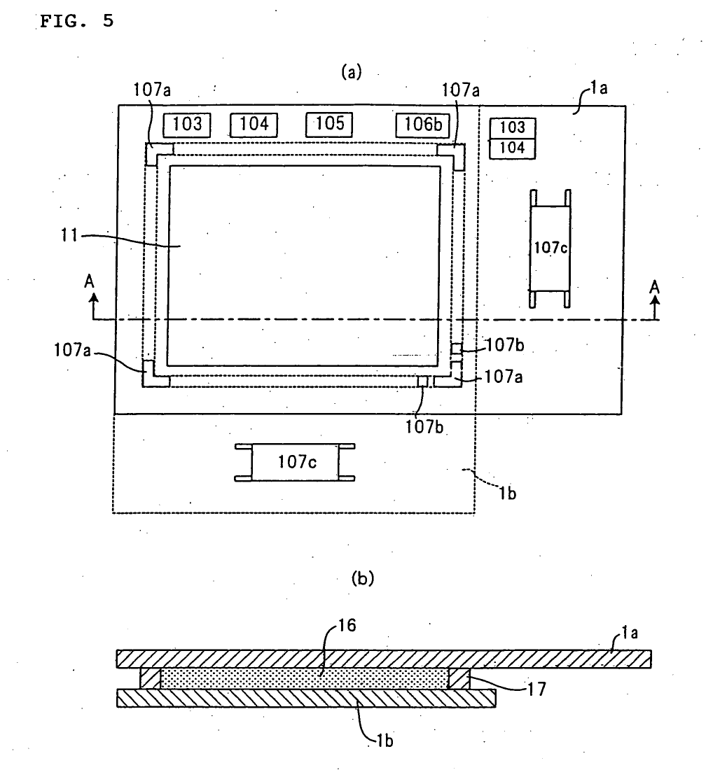

As shown in FIG. 5(a), the product information elements include panel information, such as liquid crystal-sealing positions 107a, 107b and integrated circuit-mounting positions 107c. The panel information relates to manufacturing processes of the color filter and the color liquid crystal display device. In such a structure, highly accurate and highly efficient work can be achieved in the subsequent manufacturing processes of the color filter and the color liquid crystal display device.

Since the product information elements can be formed simultaneously with the formation of the pixels by scanning the ink-jet head, the mode of information is applicable to both one-dimensional codes, such as a character, graphics, a symbol, and a bar code, and two-dimensional codes, such as verified codes. Thereby, the scope of application of the mode of the product information element can be broadened, and necessary information can be formed in an optimum mode according to the nature thereof. Since the ink-jet process is used, it is possible to distinguish the product information elements using a plurality of colors, and thus identification of information can be further enhanced. Herein, “one-dimensional code” means a code having information in one scanning direction, and “two-dimensional code” means a code having information in two different scanning directions.

As shown in FIG. 5(a), preferably, the product information elements are placed in the inside area of the outer edge of each of the color filter elements 11 placed on either end, or in the vicinity thereof, in a region other than the region in which the color filter elements 11 are placed on a substrate 1 a so that the ink-jet head can be scanned efficiently.

The liquid crystal-sealing positions 107a or 107b are used to define the position (indicated by dotted lines in FIG. 5(a)) in which a liquid crystal layer 16 is sealed by a sealing member 17, as shown in FIG. 5(b), when the color liquid crystal display device is manufactured using the color filter substrate of the present invention, and the liquid crystal-sealing positions 107a or 107b are advantageously used to manufacture the high-resolution color liquid crystal display device with high accuracy and high efficiency. The liquid crystal-sealing positions 107a or 107b may be formed in the area slightly outside of the outer edge of the color filter elements 11 placed on either end as long as they are within the scanning range of the ink-jet head.

In such a case, preferably, the material constituting the product information elements is the same as the material constituting the color filter elements 11 so that the ink-jet head can be efficiently used.

2. Method for Manufacturing Color Filter Substrate

A method for manufacturing a color filter substrate of the present invention includes the steps of forming a plurality of pixels with a predetermined spacing on a substrate by scanning an ink-jet head using an ink-jet process, and placing at least one color filter element that includes the plurality of pixels in a matrix with a predetermined spacing, wherein a product information element is placed by scanning the ink-jet head before, after, or simultaneously with the placement of the color filter element in the same plane as the plane in which the color filter element is placed or has been placed, in a region other than the region in which the color filter element is placed or has been placed on the substrate.

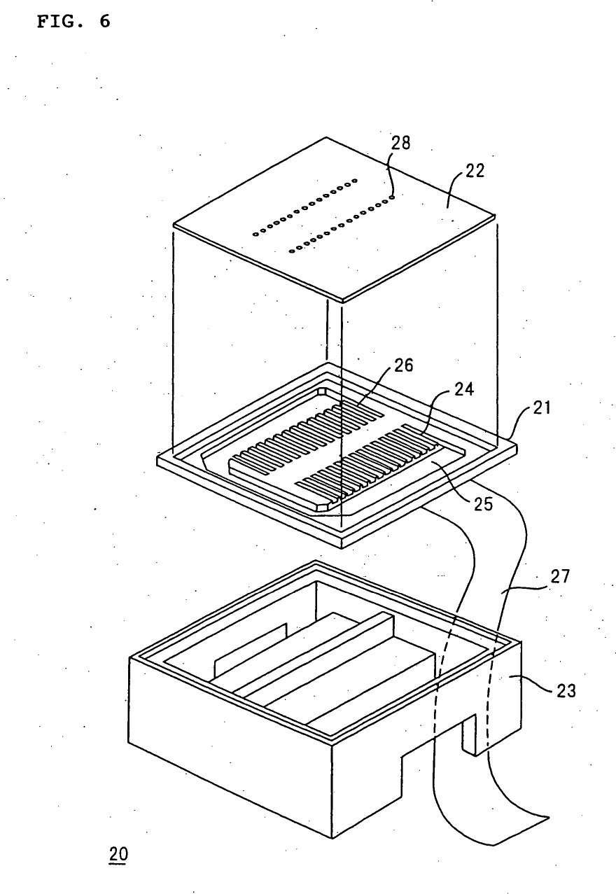

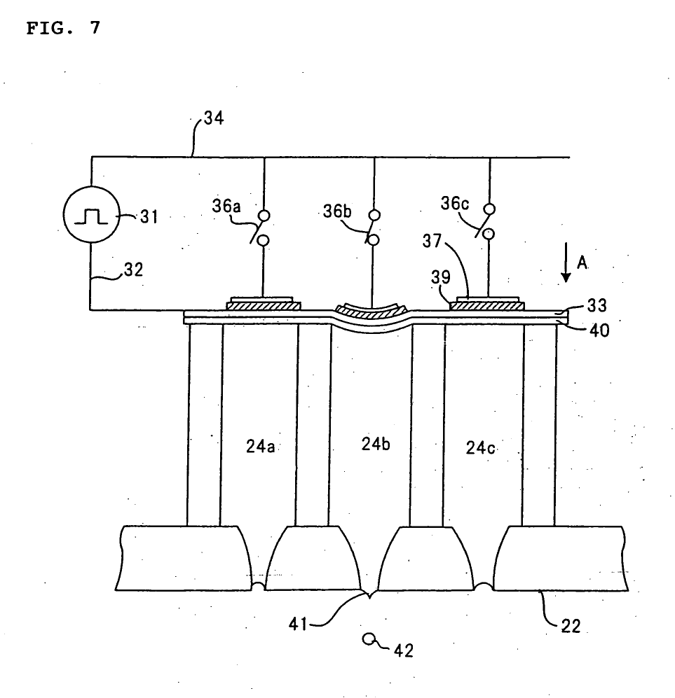

A structure of an ink-jet head used in the present invention is shown in FIG. 6. In an ink-jet head 20, an ink supply passage is formed in a pressure chamber substrate. As shown in FIG. 6, the ink-jet head 20 is mainly formed of a pressure chamber substrate 21, a nozzle plate 22, and a base 23.

A plurality of pressure chamber substrates 21 are formed on a silicon single-crystal substrate, and are then divided into the individual pressure chamber substrates. The pressure chamber substrate 21 is provided with a plurality of strip-shaped pressure chambers 24, and a common passage 25 to supply ink to all the pressure chambers 24. The individual pressure chambers 24 are separated by side walls 26. The pressure chambers 24 are arrayed in two lines, each line including 128 pressure chambers 24, and an ink-jet head having a printing density of 256 nozzles is formed. The pressure chamber substrate 21 is provided with diaphragms and piezoelectric thin-film elements at the surface facing the base 23. Lines from the individual piezoelectric thin-film elements converge on a wiring board 27, which is a flexible cable, and are connected to an external circuit (not shown in FIG. 6) of the base 23. Ink ejection timing to color the color filter is inputted to the external circuit, and ink is ejected.

The nozzle plate 22 is connected to the pressure chamber substrate 21. Nozzles 28 to eject ink droplets are formed in the nozzle plate 22 at the positions corresponding to the pressure chambers 24. The diameter of the nozzles 28 is, for example, 28 μm, and in such a case, the amount of the ink droplet ejected each time is approximately 10 pl to 20 pl. The nozzles 28 are arrayed in two lines with a predetermined pitch, and for example, the spacing between the lines and the pitch are 141 μm and 75 μm, respectively.

The base 23 is a rigid body, such as a plastic or a metal, and serves as a mount for the pressure chamber substrate 21.

FIG. 7 is a schematic diagram showing the electrical connection in the major portion of the ink jet head. One electrode of a driving power supply 31 is connected to a lower electrode 33 of the ink jet head via a line 32. The other electrode of the driving power supply 31 is connected to upper electrodes 37, which correspond to pressure chambers 24a to 24c, via a line 34 and switches 36a to 36c.

In FIG. 7, only the switch 36b for the pressure chamber 24b is on, and the other switches 36a and 36c are off. The pressure chambers 24a and 24c, in which the switches 36a and 36c are off, are on standby mode for the ink ejection. When the ink is ejected, a switch is turned on, as in the switch 36b, and a voltage is applied to the piezoelectric film. The voltage is applied in the same direction as the polarization direction of the piezoelectric film 39 indicated by the arrow A in FIG. 7, that is, the voltage is applied in the same manner as that of the polarity of the applied voltage during polarization. The piezoelectric film 39 expands in the thickness direction and shrinks in a direction perpendicular to the thickness direction. The shrinkage produces stress at the interface between the piezoelectric film 39 and the diaphragm 40, and the piezoelectric film 39 and the diaphragm 40 are flexed downward. The volume of the pressure chamber 24b is decreased by this flexure, and an ink droplet 42 is ejected from a nozzle 41. The ink droplet 42 colors the pixel. When the switch 36b is turned off again, the flexed piezoelectric film 39 and diaphragm 40 are restored, and the volume of the pressure chamber 24b expands, and ink is thereby filled into the pressure chamber 24b from an ink supply passage (not shown in FIG. 7). Additionally, the oscillation frequency of the piezoelectric film 39 is 7.2 kHz.

In the present invention, as described above, preferably, the product information element contains at least one type of substrate information selected from a group that includes a lot number, a manufacturing condition, a position of the color filter element, a defective notice, a flow time, a manufacturing apparatus number, and a manufacturing apparatus head number; the product information element contains at least one type of panel information selected from a group that includes a liquid crystal-sealing position and an integrated circuit-mounting position when a color filter or a color liquid crystal display device is manufactured using the color filter substrate; the product information element contains at least one type of information selected from a group that includes a character, graphics, a symbol, a bar code, and a verified code; the scanning range of the ink-jet head to place the product information element agrees with the scanning range of the ink-jet head to place the color filter element; and the material constituting the product information element is the same as the material constituting the color filter element.

The method for manufacturing the color filter substrate described above may be repeated a plurality of times, and when the color filter element and the product information element are placed on each of the plurality of substrates, the individual substrates may have different product information elements arranged on a plurality of substrates.

3. Color Liquid Crystal Display Device

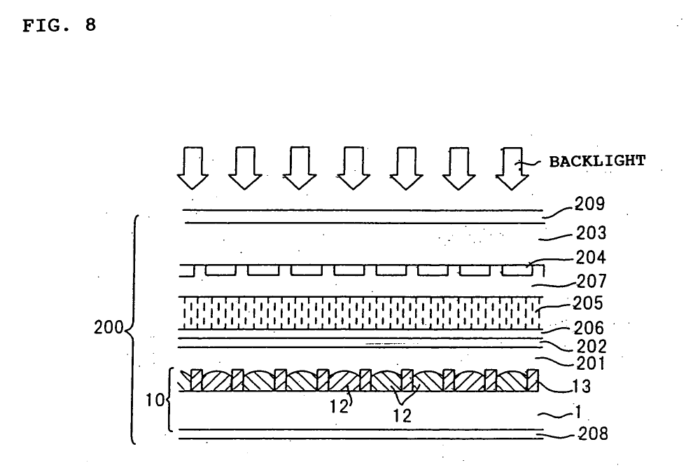

As shown in FIG. 8, a color liquid crystal display device 200 of the present invention includes a panel chip cut from the color filter substrate 10 described above so as to contain a predetermined number of color filter elements 11 and product information elements (not shown in FIG. 8); and a protective layer 201, a common electrode 202, a pixel electrode substrate 203, a pixel electrode 204 provided on the pixel electrode substrate 203 so as to be opposed to the common electrode 202, and a liquid crystal layer 205 interposed and sealed between the two opposed electrodes 202 and 204 which are provided on the panel chip.

In the color liquid crystal display device 200 of the present invention, preferably, alignment films 206 and/or 207 are provided between the common electrode 202 and the liquid crystal layer 205 and/or between the liquid crystal layer 205 and the pixel electrode substrate 203, respectively.

Preferably, polarizers 208 and/or 209 are provided on an outer surface of the substrate 1 used for the color filter substrate 10 and/or on an outer surface of the pixel electrode substrate 203.

Preferably, the liquid crystal layer 205 is interposed and sealed at a position corresponding to the liquid crystal-sealing position 107a or 107b (refer to FIG. 5) constituting the product information element between the two opposed electrodes 202 and 204. Preferably, an integrated circuit (not shown in FIG. 8) is mounted at a position corresponding to the integrated circuit-mounting position 107b (refer to FIG. 5) constituting the product information element on the panel chip so that a color liquid crystal display device is obtained with high accuracy.

Additionally, the materials used for the constituents described above are not particularly limited, and commonly used materials may be used therefor.

Although a transmissive color liquid crystal display device is shown in FIG. 8, the present invention is also applicable to a so-called reflective color liquid crystal display device in which an image is displayed by reflecting light entering from the front surface.

4. Method for Manufacturing Color Liquid Crystal Display Device

A method for manufacturing a color liquid crystal display device in the present invention includes the steps of forming a color filter substrate by the method for manufacturing a color filter substrate described above; cutting a panel chip that contains a predetermined number of color filter elements and product information elements from the color filter substrate; referring to the substrate information and the panel information that constitute the product information element; forming a protective layer and a common electrode on the panel chip; forming a pixel electrode on a pixel electrode substrate so as to be opposed to the common electrode; and interposing and sealing a liquid crystal layer between the opposed two electrodes.

In such a case, preferably, an alignment film is formed between the common electrode and the liquid crystal layer and/or between the liquid crystal layer and the pixel electrode substrate.

Preferably, a polarizer is formed on an outer surface of the substrate that is used as the color filter substrate and/or on an outer surface of the pixel electrode substrate.

Preferably, the liquid crystal layer is interposed and sealed at a position corresponding to the liquid crystal-sealing position constituting the product information element between the two opposed electrodes, and an integrated circuit is mounted at a position corresponding to the integrated circuit-mounting position constituting the product information element on the panel chip so that a color liquid crystal display device is obtained with high accuracy.

As described above, in accordance with the present invention, it is possible to provide a color filter substrate that is provided with various types of product information that is necessary to manufacture a high-resolution color filter and a high-resolution color liquid crystal device with high accuracy and high efficiency.

In accordance with the present invention, it is also possible to provide a method for manufacturing a color filter substrate in which a color filter substrate that is provided with various types of product information necessary to manufacture a high-resolution color filter and a high-resolution color liquid crystal device with high accuracy and high efficiency can be manufactured efficiently without an additional manufacturing step, without adding a special unit to an ink-jet head, and without adding a special operation, etc.

In accordance with the present invention, it is also possible to provide a color liquid crystal display device using the color filter substrate that is capable of performing a high-resolution display, and to provide a method for manufacturing a color liquid crystal display device in which a high-resolution color liquid crystal display device can be manufactured with high accuracy and high efficiency using the method for manufacturing the color filter substrate.

What is claimed is:

1. A method for manufacturing a color filter substrate comprising the steps of:
forming a plurality of pixels with a predetermined spacing at a first region on a substrate by scanning an ink-jet head using an ink-jet process;
placing at least one color filter element that includes the plurality of pixels in a matrix with a predetermined spacing; and
placing a product information element by scanning the ink-jet head before, after, or simultaneously with the placement of the color filter element in a same plane as a plane in which the color filter element is placed or has been placed, in a second region that is other than the first region in which the color filter element is placed or has been placed on the substrate.

2. The method for manufacturing a color filter substrate according to claim 1, the placing step including placing a product information element that contains at least one type of substrate information selected from the group consisting of a lot number, a manufacturing condition, a position of the color filter element, a defective notice, a flow time, a manufacturing apparatus number, and a manufacturing apparatus head number.

3. The method for manufacturing a color filter substrate according to claim 1, the placing step including placing a product information element that contains at least one type of panel information selected from the group consisting of a liquid crystal-sealing position and an integrated circuit-mounting position when the color filter or the color liquid crystal display device is manufactured using the color filter substrate.

4. The method for manufacturing a color filter substrate according to claim 1, the placing step including placing a product information element that contains at least one type of information selected from the group consisting of a character, graphics, a symbol, a bar code, and a verified code.

5. The method for manufacturing a color filter substrate according to claim 1, further including matching the scanning range of the ink-jet head for placing the product information element with the scanning range of the ink-jet head for placing the color filter element.

6. The method for manufacturing a color filter substrate according to claim 1, further including utilizing a material to constitute the product information element that is the same as the material that constitutes the color filter element.

7. A method for manufacturing color filter substrates, comprising:
repeatedly performing the method for manufacturing a color filter substrate according to claim 1 a plurality of times so that the color filter element and the product information element are placed on each of a plurality of substrates, the individual substrates having different product information elements.

8. A method for manufacturing a color liquid crystal display device, comprising the steps of:
forming a color filter substrate by the method for manufacturing a color filter substrate according to claim 1;
cutting a panel chip containing a predetermined number of color filter elements and product information elements from the color filter substrate;
referring to the substrate information and the panel information constituting the product information element;
forming a protective layer and a common electrode on the panel chip;
forming a pixel electrode on a pixel electrode substrate so as to be opposed to the common electrode; and
interposing and sealing a liquid crystal layer between the two opposed electrodes.

9. The method for manufacturing a color liquid crystal device according to claim 8, further comprising the step of forming an alignment film at at least one of between the common electrode and the liquid crystal layer and between the liquid crystal layer and the pixel electrode substrate.

10. The method for manufacturing a color liquid crystal display device according to claim 8, further comprising the step of forming a polarizer at at least one of an outer surface of the substrate used for the color filter substrate and on an outer surface of the pixel electrode substrate.

11. The method for manufacturing a color liquid crystal display device according to claim 8, the liquid crystal layer being interposed and sealed at a position corresponding to the liquid crystal-sealing position constituting the product information element between the two opposed electrodes.

12. The method for manufacturing a color liquid crystal display device according to claim 8, further including an integrated circuit mounted at a position corresponding to the integrated circuit-mounting position constituting the product information element on the panel chip.
